(19) United States
(12) Patent Application Publication
(10) Pub. No.: US 2012/0076892 A1
(43) Pub. Date: Mar. 29, 2012

(54) PROCESS FOR ENCAPSULATING AN ACTIVE INGREDIENT

(76) Inventors: Maurus Marty, Vich (CH); Dana Zampieri, Landecy (CH)

(21) Appl. No.: 13/322,623

(22) PCT Filed: Jun. 15, 2010
(86) PCT No.: PCT/IB2010/052682

§ 371 Date: Nov. 28, 2011

(30) Foreign Application Priority Data
Jun. 30, 2009 (EP) 09164167.0

(51) Int. Cl. A23P 1/08; A23L 1/09; A21D 13/00; A23G 4/20; A23L 1/10; A21D 10/00; A21D 10/04

(52) U.S. Cl. 426/5; 426/665; 426/496; 426/520; 426/89; 426/103; 426/94

(57) ABSTRACT

The present invention relates to the field of encapsulation. More particularly, it relates to a process for encapsulating an active ingredient such as preferably flavouring ingredients in or on an edible composition, the encapsulating material comprising empty yeast cells. Furthermore a food product containing said encapsulated active ingredient which is preferably in the form of a chewing-gum, a fried, baked or extruded product.

### TECHNICAL FIELD

The present invention relates to the field of encapsulation. More particularly, it relates to a new process for encapsulating an active ingredient in or on an edible composition.

### PRIOR ART

Processes for preparing encapsulated active ingredients are developed in various industries to protect active ingredients. For instance, in the food industry lots of processes for the encapsulation of flavors are known. Encapsulation mainly has the objective of avoiding losses of volatile components (i) during storage prior to incorporation into the food products, (ii) during mixing of the flavor component with the other food ingredients, (iii) during food processing, such as cooking and baking, (iv) during transportation and storage and (v) during the preparation of the food product by the end-consumer.

Similarly, in the nutraceutical industry, encapsulation aims to protect oxygen-sensitive active materials, such as fish oils rich in polyunsaturated fatty acids, by providing an oxygen barrier around the material.

In the flavours industry, a highly desirable benefit of encapsulation is that of having high thermal stability while providing a controlled release of the active upon consumption of the food product. One approach to address this issue is by the encapsulation of flavouring compounds into microorganism walls. This has been described in a number of prior art documents. This type of capsules are always the object of a pre-preparation step in which the active ingredient is added to an aqueous dispersion of the microorganism. The so prepared capsules are then dried before being incorporated into food products.

For example, US 2005/0118273 describes a process for the encapsulation of flavours in yeast. A capsule slurry is prepared by adding the flavour to an aqueous dispersion of yeast. Saccharides are adhered to the surface of yeast cell bodies. The obtained capsules are then spray-dried and the spray dried powder is used for the flavouring of food products.

It would be advantageous to avoid the pre-preparation step and to develop a simplified process, thus saving time and costs. Furthermore, drying before incorporation of the capsules to the food product could also be omitted, thus avoiding yield loss.

It is therefore desirable to address one or more of these problems by providing a process for encapsulating an active ingredient directly in an edible composition, thus avoiding the pre-preparation step.

### SUMMARY OF THE INVENTION

The present invention provides a process for preparing an encapsulated active ingredient in or on an edible composition comprising the steps of
a) adding to the edible composition
   i) an active ingredient; and separately
   ii) an encapsulating material comprising empty microorganism cells;
b) optionally heating the active ingredient prior to, during and/or after addition to the edible composition to ensure that the active ingredient is in a liquid state;
c) after addition of the active ingredient and of the encapsulating material to the edible composition in step a), intimately contacting the liquid active ingredient with the encapsulating material in or on the edible composition so as to enable the liquid active ingredient to be encapsulated within the encapsulating material.

In another aspect, the invention provides a food product containing an encapsulated active ingredient obtained by the above-described process.

### DETAILED DESCRIPTION

The present inventors have surprisingly found a new simplified process for the preparation of an encapsulated active ingredient in a microorganism which does not require any pre-preparation step. The present process brings a surprising contribution to the encapsulation art because, in view of what is known in this field, namely that the capsule should be pre-loaded with the active ingredient prior to incorporation into a foodstuff, it was not expected that active ingredients would effectively diffuse into the encapsulating material when mixed in or on an edible composition. Indeed, such a composition contains diverse ingredients having properties different from those of water, in which the encapsulation takes place in all prior art documents. In particular the presence of hydrophobic components in the composition would be expected to change the ability of the flavouring ingredients to migrate into the encapsulating material.

In the first step of the process, the active ingredient and the encapsulating material are separately added to the edible composition. In the context of the present invention, “added separately” means that the encapsulating material is not pre-loaded with the active ingredient.

The active ingredient can be any edible active ingredient in liquid form. It can also be in solid form at ambient temperature and pressure (25° C., 1 atm). In such case, it must be melted to ensure that it can mix intimately with the encapsulating material. Step b) of the process is therefore mandatory when the active ingredient is in solid form at ambient temperature. Melting can be performed in any suitable manner, such as by heating using any standard apparatus. The melting step can occur before, during or after the active ingredient is added to the edible composition, as long as it is maintained in a melted state for a sufficient time to achieve encapsulation. The active ingredient can be selected within a wide range of actives such as pharmaceuticals, vitamins and food additives, such as taste enhancers, aromas or flavours, for example.

In a preferred aspect of the invention, the active ingredient is characterized by a logP value of at least 1.5 or even preferably of at least 2. For the purpose of the invention, “logP” is meant as calculated logP as obtained using the EPI suite v3.10; 2000 U.S. Environmental Protection Agency.

Preferably, the active ingredient is a flavouring ingredient. For the purpose of the present invention, a “flavouring ingredient” means a compound, which is used in flavouring preparations or compositions to impart a hedonic effect. In other words such an ingredient, to be considered as being a flavouring ingredient, must be recognized by a person skilled in the art as being able to impart or modify in a positive or pleasant way the taste of a composition.

The nature and type of the flavouring ingredients that may be present do not warrant a more detailed description here, which in any case would not be exhaustive, the skilled person being able to select them on the basis of his general knowledge and according to the intended use or application and the desired organoleptic effect. In general terms, these flavouring ingredients belong to chemical classes as varied as alcohols, aldehydes, ketones, esters, ethers, acetates, nitriles, terpenoids, nitrogenous or sulphurous heterocyclic compounds and essential oils, and can be of natural or synthetic origin. Many of these flavouring ingredients are listed in reference texts such as the book by S. Arctander, Perfume and Flavor Chemicals, 1969, Montclair, N.J., USA, or its more recent versions, or in other works of a similar nature, as well as in the abundant patent literature in the field of flavour. It is also understood that the flavouring ingredients may also be compounds known to release in a controlled manner various types of flavouring compounds.

The active ingredient may be a single compound or a mixture of compounds, optionally having different activities. It is particularly advantageous to use a mixture of flavoring compounds optionally together with other actives such as food additives or pharmaceuticals.

The encapsulating material comprises empty microorganism cells. Any empty microorganism can be used, but yeast cells are particularly appreciated. By “empty microorganism cells” we mean that the inner content of the cell has been removed and that no flavours have been encapsulated in the microorganism prior to the present process.

The encapsulating material can consist of the microorganism cells alone. Alternatively the microorganism cell can be combined with any additional component such as for example a matrix component. The matrix component is preferably suitable to form a polymer matrix. A vast number of structurally different matrix-forming compounds or compositions exist, some of which are mentioned below.

The matrix component may, for example, be formed of or comprise a protein or a carbohydrate. Any matrix component which can be associated with a microorganism cell for the encapsulation of a liquid active ingredient can be used. The nature of suitable matrix component, which would in any case not be exhaustive, is not further detailed here, the skilled person being able to select the suitable matrix component on the basis of his general knowledge or of the teaching of any document relating to the encapsulation of active ingredients in microorganisms.

The microorganism may be pre-treated for increasing its permeability for the active ingredient or for removing the sometimes undesired odour or aroma of the microorganism, for example, using any suitable technique known to the person skilled in the art.

The edible composition is defined as any liquid or solid mixture of ingredients that is intended to be converted into an edible product through normal processing, either alone or in combination with other components. Water as such is therefore not considered as an edible composition for the purpose of the present invention. To be considered as an edible composition water must be admixed with further ingredients. In a preferred aspect of the invention, the active ingredient and the encapsulating material are incorporated into a syrup or a batter. The syrup or batter is preferably used to form the coating part of an edible product, more preferably the coating part of a chewing-gum, of an extruded product or of a product intended to be fried, most preferably the coating part of a chewing-gum, a cereal product or French fries. In another preferred embodiment, the active ingredient and the encapsulating material are incorporated in dough. The dough is preferably intended to be used in baked or fried products, in particular fritters or savoury products.

In the second step of the process, which is optional, the active ingredient is heated to ensure that it is in a liquid state. In the case of an already liquid active ingredient, this step is not necessary but it can be desirable to heat the mixture anyway, in order to increase the encapsulation rate.

When the active ingredient is in solid form at ambient temperature, heating such ingredient above its melting point so that it is in a liquid state in the presence of the encapsulating material is necessary for it to diffuse into the microorganism and for the encapsulation to take place. Step b) can be carried out either before and/or during step a), between step a) and step c) or even simultaneously with step c).

In the third step of the process, the active ingredient in liquid form is intimately contacted with the encapsulating material in or on the edible composition. Preferably, the active ingredient in liquid form is intimately contacted with the encapsulating material in the edible composition, in which case the process of the present invention is a process for preparing an encapsulated active ingredient in an edible composition.

Intimate contact is achieved by mixing the composition obtained in step a), optionally after or while heating, using any method known in the art, in particular by low shear mixing, high shear mixing or homogenizing the mixture, preferably by high shear mixing or homogenizing it. Intimate contact between the liquid active ingredient and the encapsulating material enables the liquid active ingredient to diffuse into the microorganism through the wall, thus effecting encapsulation.

Intimately contacting and/or heating the mixture can be done as a part of the necessary preparation steps of the final product, for example extruding, baking and/or frying.

The encapsulation rate is very much dependent on the temperature. When the mixture is heated to a temperature of 40° C., the active ingredient is encapsulated in a period of from 1 to 2 hours. When it is carried out at a temperature of about 30° C., the encapsulation takes place in a period of about 4 hours. At 20° C. the encapsulation will take about 16 hours to be completed. A process including heating the mixture above 40° C. is therefore particularly advantageous.

The obtained encapsulated ingredient is thus incorporated directly in a food product or in a part of a food product. Such food product, which is also an object of the present invention, is then prepared according to any conventional method known to the skilled person. Therefore, the preparation steps of the final food product are not described in further details here. In any case, these steps don't have specific consequences on the encapsulation process, which can take place in any type of flavoured product base.

Preferred target applications are chewing-gums which are coated with a flavoured syrup prepared according to the process of the invention. Other preferred final products include extruded, baked and fried food products containing dough prepared according to the process of the invention, for example fritters, or coated with a syrup or a batter prepared according to the process of the present invention. The present process is particularly appreciated for encapsulation of flavours for use in savoury applications.

The active ingredient encapsulated by the process of the invention is released in a controlled manner from the food product under the effect of predetermined factors such as the presence of a minimum amount water. These factors are dependent on the exact nature of the encapsulating material and in particular of the type of microorganism and of the optional matrix used. The exact nature of the encapsulating material is determined by the person skilled in the art on the basis of the conditions in which the food product will be consumed. These release conditions are known to the person skilled in the art and are therefore not disclosed in further details here.

### DESCRIPTION OF THE DRAWINGS

FIG. 1: Graph summarizing the results of the analytical measurements of total remaining flavour load in the coating syrups of Examples 1 to 4.

FIG. 2: Graph summarizing the results of the sensory evaluation of the chewing-gums of Example 5.

FIG. 3: Graph summarizing the results of the sensory evaluation of the cereals of Example 7 in dry form.

FIG. 4: Graph summarizing the results of the sensory evaluation of the cereals of Example 7 mixed with semi-skimmed milk.

FIG. 5: Graph summarizing the results of the sensory evaluation of the French fries of Example 9.

### EXAMPLES

The invention will now be described in further detail by way of the following Examples.

### Example 1

### Preparation of an Encapsulated Banana Flavour in a Coating Syrup

A coating syrup (Coating A) was prepared with the ingredients listed in the table below, in the amounts indicated.

TABLE 1
Composition of Coating A

| Ingredient | Amount [g] |
|---|---|
| Water | 386.7 |
| Maltisorb P200¹⁾ | 570.3 |
| Arabic gum²⁾ | 19.6 |
| Titanium dioxide³⁾ | 4.9 |
| Liquid flavour⁴⁾ | 5.55 |
| Encapsulating materials⁵⁾ | 12.95 |

¹⁾Origin: Roquette.
²⁾Gomme instant IRX 49345, origin: Colloides Naturel International.
³⁾Origin: Precolor.
⁴⁾Mixture of flavouring ingredients having a banana note, n° 885043 TTB0299, origin: Firmenich SA, Geneva, Switzerland.
⁵⁾S. Cerevisiae,item 954794, origin: Firmenich SA, Geneva, Switzerland.

The ingredients listed above were mixed in a beaker to form a slurry. The slurry was then mixed with a high shear mixer (IKA T18 basic Ultra Turrax®) at 20′000 rpm for 30 seconds at 40° C. and then stirred with a conventional stirrer at 40° C. for 2 hours leading to 1 kg of coating syrup.

A control sample (Coating B) was prepared using the above-described technique with the same ingredients in the same amounts, except the encapsulating material, which was omitted.

### Example 2

### Preparation of an Encapsulated Apple Flavour in a Coating Syrup

A coating syrup (Coating C) was prepared with the ingredients listed in the table below, in the amounts indicated.

TABLE 2
Composition of Coating C

| Ingredient | Amount [g] |
|---|---|
| Water | 386.7 |
| Maltisorb P200¹⁾ | 570.3 |
| Arabic gum²⁾ | 19.6 |
| Titanium dioxide³⁾ | 4.9 |
| Liquid flavour⁴⁾ | 5.55 |
| Encapsulating materials⁵⁾ | 12.95 |

¹⁾Origin: Roquette.
²⁾Gomme instant IRX 49345, origin: Colloides Naturel International.
³⁾Origin: Precolor.
⁴⁾Mixture of flavouring ingredients having an apple note, n° 885042 TTB0299, origin: Firmenich SA, Geneva, Switzerland.
⁵⁾S. Cerevisiae, item 954794, origin: Firmenich SA, Geneva, Switzerland.

The ingredients listed above were mixed in a beaker to form a slurry. The slurry was then mixed with a high shear mixer (IKA T18 basic Ultra Turrax®) at 20′000 rpm for 30 seconds at 40° C. and then stirred with a conventional stirrer at 40° C. for 2 hours leading to 1 kg of coating syrup.

A control sample (Coating D) was prepared using the above-described technique with the same ingredients in the same amounts, except the encapsulating material, which was omitted.

### Example 3

### Preparation of an Encapsulated Mint Flavour in a Coating Syrup

A coating syrup (Coating E) was prepared with the ingredients listed in the table below, in the amounts indicated.

TABLE 3
Composition of Coating E

| Ingredient | Amount [g] |
|---|---|
| Water | 381.1 |
| Maltisorb P200¹⁾ | 561.9 |
| Arabic gum²⁾ | 19.3 |
| Titanium dioxide³⁾ | 4.8 |
| Liquid flavour⁴⁾ | 5.35 |
| Encapsulating materials⁵⁾ | 27.5 |

¹⁾Origin: Roquette.
²⁾Gomme instant IRX 49345, origin: Colloides Naturel International.
³⁾Origin: Precolor.
⁴⁾Mixture of flavouring ingredients having a mint note, n° 885106 TTB0399, origin: Firmenich SA, Geneva, Switzerland.
⁵⁾S. Cerevisiae, item 954794, origin: Firmenich SA, Geneva, Switzerland.

The ingredients listed above were mixed in a beaker to form a slurry. The slurry was then mixed with a high shear mixer (IKA T18 basic Ultra Turrax®) at 20′000 rpm for 30 seconds at 40° C. and then stirred with a conventional stirrer at 40° C. for 2 hours leading to 1 kg of coating syrup.

A control sample (Coating F) was prepared using the above-described technique with the same ingredients in the same amounts, except the encapsulating material, which was omitted.

### Example 4

### Preparation of an Encapsulated Grapefruit Flavour in a Coating Syrup

A coating syrup (Coating G) was prepared with the ingredients listed in the table below, in the amounts indicated.

TABLE 4
Composition of Coating G

| Ingredient | Amount [g] |
|---|---|
| Water | 385.5 |
| Maltisorb P200¹⁾ | 568.5 |
| Arabic gum²⁾ | 19.6 |
| Titanium dioxide³⁾ | 4.9 |
| Liquid flavour⁴⁾ | 5.38 |
| Encapsulating materials⁵⁾ | 16.1 |

¹⁾Origin: Roquette.
²⁾Gomme instan IRX 49345, origin: Colloides Naturel International.
³⁾Origin: Precolor.
⁴⁾Mixture of flavouring ingredients having a grapefruit note, n° 885108 TTB0399, origin: Firmenich SA, Geneva, Switzerland.
⁵⁾S. Cerevisiae, item 954794, origin: Firmenich SA, Geneva, Switzerland.

The ingredients listed above were mixed in a beaker to form a slurry. The slurry was then mixed with a high shear mixer (IKA T18 basic Ultra Turrax®) at 20′000 rpm for 30 seconds at 40° C. and then stirred with a conventional stirrer at 40° C. for 2 hours leading to 1 kg of coating syrup.

A control sample (Coating H) was prepared using the above-described technique with the same ingredients in the same amounts, except the encapsulating material, which was omitted.

### Example 5

### Preparation of Chewing-Gum Coated with a Syrup Containing an Encapsulated Flavour and Analysis

### Preparation

The freshly prepared coating syrups of Example 1 to 4 (Coatings A to H) were respectively used to coat classical pellet chewing gums in an industrial coater in 80-100 cycles until the weight of the chewing gum increased by about 40%. Chewing-gum A to H were thus obtained.

### Analytical Measurements

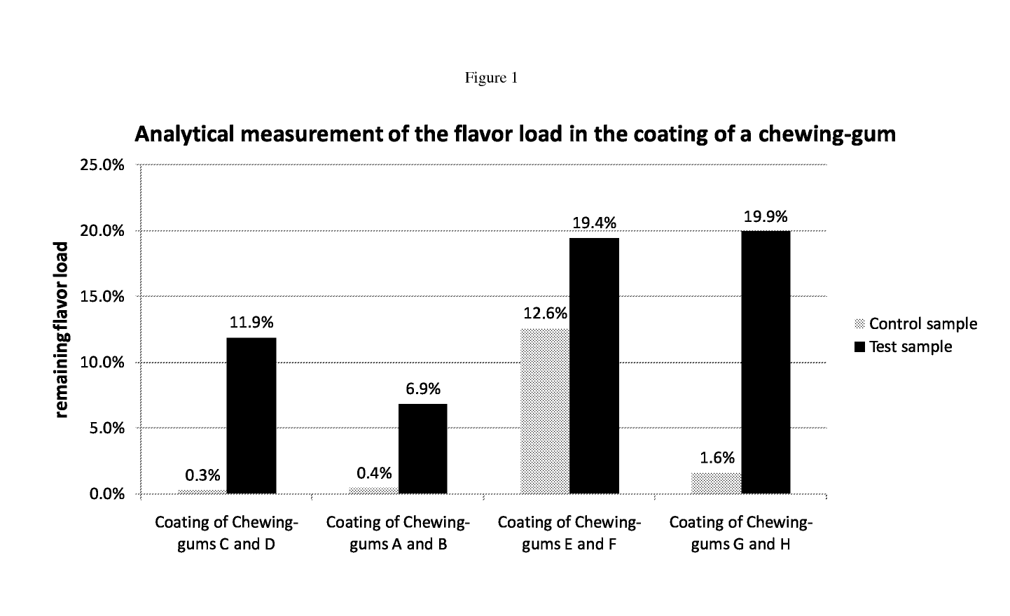

Analytical measurements were carried out to determine the total flavour load in the coating of each of Chewing-gums A to H. The results are shown in FIG. 1. The total amount of flavour in the coating of Chewing-gums A, C, E and G (test samples with the encapsulated active ingredient) is considerably higher than in the coating of Chewing-gums B, D, F and H (control samples with the free flavour), showing that all of the tested flavours are successfully encapsulated and that flavour loss is effectively avoided during the preparation of the coating syrup and the successive coating of the chewing-gum.

### Sensory Analysis

Chewing-gums A and B were submitted to a panel of 12 trained panellists on a blind test basis. They were asked to rate the flavour strength of both samples on a scale ranging from 1 to 5, where 1 is weak flavour and 5 is strong flavour.

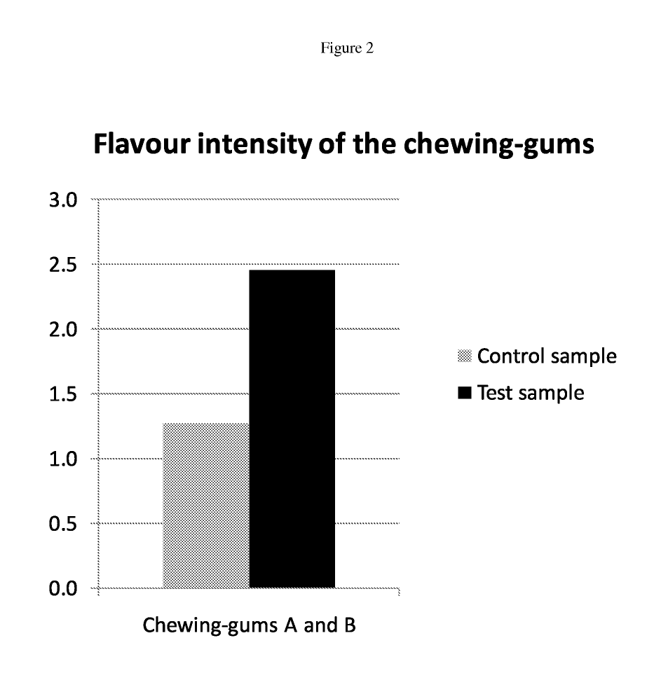

The results are shown in FIG. 2. The banana flavour was perceived much stronger in Chewing-gum A, which contains the encapsulated flavour, than in Chewing-gum B, which contains the free flavour, thus showing that the effect of encapsulation is clearly perceivable by the consumer in the coated chewing-gum of the invention.

### Example 6

### Preparation of an Encapsulated Berry Flavor in a Coating Syrup

A coating syrup (Coating I) was prepared with the ingredients listed in the table below, in the amounts indicated.

TABLE 5
Composition of Coating syrup I

| Ingredient | Amount [g] |
|---|---|
| Water | 34.0 |
| Sugar | 65.0 |
| Liquid flavour¹⁾ | 0.25 |
| Encapsulating | 0.50 |
| material²⁾ | |

¹⁾Mixture of flavouring ingredients having a berry note, n° 885110, origin: Firmenich SA, Geneva, Switzerland.
²⁾S. Cerevisiae, item 954794, origin: Firmenich SA, Geneva, Switzerland.

The water and sugar were mixed in a beaker to form a solution. To this solution was added the liquid flavour and the encapsulating material. The resulting slurry was then mixed with a high shear mixer (IKA T18 basic Ultra Turrax®) at 20′000 rpm for 30 seconds at 40° C. and then stirred with a conventional stirrer at 40° C. for 2 hours leading to 99.75 g of coating syrup.

A control sample (Coating J) was prepared using the above-described technique for coating J with the same ingredients in the same amounts, except the encapsulating material, which was omitted.

### Example 7

### Preparation of Cereals Coated with a Sugar Syrup Containing an Encapsulated Berry Flavour and Sensory Analysis

### Preparation

The freshly prepared coating syrups of Example 6 (Coatings I and J) were respectively used to coat classical corn flakes cereals in a pan coater by adding 60 g of the syrup to 300 g of the cereals over a 15 minutes time period and by heating the coating pan from the outside with a heat gun in order to obtain a temperature of 25°-35° C. within the pan coater.

### Sensory Analysis

Cereals coated with Coatings I and J were submitted to a panel of 24 trained panellists on a blind test basis. They were asked to rate the flavour strength of both samples as dry cereals and in semi-skimmed milk on a scale ranging from 1 to 10, where 1 is weak flavour and 10 is strong flavour.

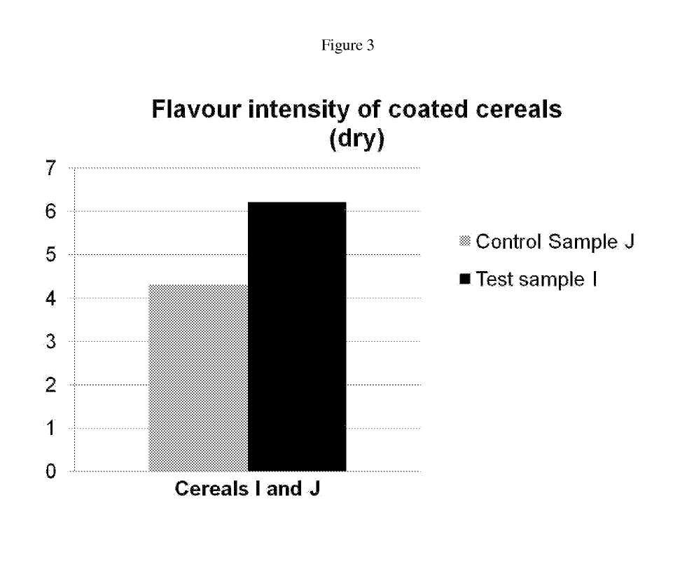

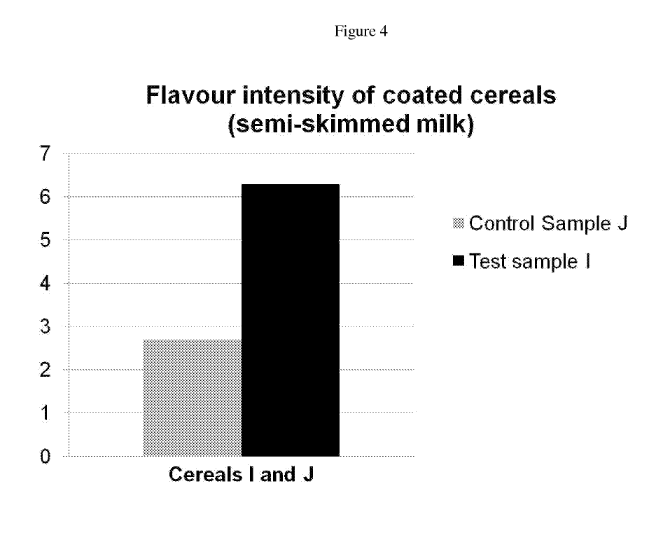

The results are shown in FIGS. 3 and 4. The berry flavour was perceived much stronger in the cereals coated with Coating I, which contains the encapsulated flavour, than in the cereals coated with Coating J, which contains the free flavour, thus showing that the effect of encapsulation is clearly perceivable by the consumer in the coated cereals of the invention.

### Example 8

### Preparation of an Encapsulated Garlic Flavor in a Coating Batter

A batter (Coating K) was prepared with the ingredients listed in the table below, in the amounts indicated.

TABLE 6
Composition of Coating K

| Ingredient | Amount [g] |
|---|---|
| Water | 59.7 |
| Table salt¹⁾ | 1 |
| Glaze²⁾ | 39 |
| Liquid flavour³⁾ | 0.1 |
| Encapsulating | 0.2 |
| material⁴⁾ | |

¹⁾Item 981185, origin: Firmenich SA, Geneva, Switzerland.
²⁾Glaze for potato product, origin: Griffith BGB1214
³⁾Garlic oil, item 905097, origin: Firmenich SA, Geneva, Switzerland.
⁴⁾S. Cerevisiae, item 954794, origin: Firmenich SA, Geneva, Switzerland.

The ingredients listed above were mixed in a three-necked round bottom flask equipped with a heating system, thermometer and mechanical stirrer (IKA Labortechnik RW20) to form a slurry. The slurry was heated to 40° C. and stirring was continued during 2 hours.

A control sample (Coating L) was prepared using the above-described technique with the same ingredients in the same amounts, except the encapsulating material, which was omitted.

### Example 9

### Preparation of French Fries Coated with a Batter Containing an Encapsulated Garlic Flavour and Sensory Analysis

### Preparation

French Fries (Mc Cain Tradition French Fries) were coated using Coatings K and L. After draining they were fried at 190° C. for 1 minute in a traditional frying pan and then frozen for 2 days. Right before consumption the French fries were fried again at 180° C. for 3 minutes and 30 seconds.

### Sensory Analysis

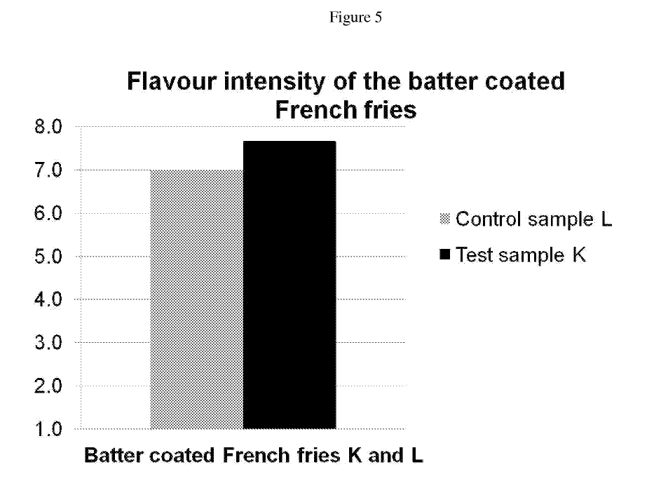

French Fries coated with Coating K and L were submitted to a panel of 9 trained panellists on a blind test basis. They were asked to rate the flavour strength of both samples on a scale ranging from 1 to 10, where 1 is weak flavour and 10 is strong flavour. The results are shown in FIG. 5. The flavour was perceived stronger in French Fries coated with Coating K, which contain the encapsulated flavour, than in French Fries coated with Coating L, which contain the free flavour, thus showing that the effect of encapsulation is clearly perceivable by the consumer in the coated French Fries of the invention.

1.-12. (canceled)

13. A process for preparing an encapsulated active ingredient in or on an edible composition which comprises:
adding, separately, to an edible composition an active ingredient and an encapsulating material comprising empty microorganism cells, with the active ingredient being present in a liquid state optionally with heating prior to, during or after its addition to the edible composition; and
intimately contacting the liquid active ingredient with the encapsulating material in or on the edible composition in a manner such that the liquid active ingredient becomes encapsulated within the encapsulating material.

14. The process of claim 13, which further comprises selecting the edible composition to be a syrup or batter composition so that the liquid active ingredient is encapsulated within the encapsulating material in or on the syrup or batter composition.

15. The process of claim 13, which further comprises selecting the edible composition to be a dough.

16. The process of claim 13, which further comprises selecting the edible composition to be one that is extrudable.

17. The process of claim 13, which further comprises selecting the encapsulating material to comprise empty yeast cells.

18. The process of claim 13, which further comprises combining the empty cells with a matrix component prior to encapsulating the active ingredient.

19. The process of claim 13, which further comprises selecting the active ingredient to be a flavour.

20. The process of claim 13, which further comprises selecting the active ingredient to have a logP of at least 1.5.

21. The process of claim 13, wherein the intimately contacting further comprises heating the liquid active ingredient and the encapsulating ingredient to a temperature of at least 40° C.

22. A food product containing an encapsulated ingredient obtained by the process of claim 13.

23. The food product of claim 22, wherein the edible composition is a coating syrup or batter.

24. The food product of claim 22, wherein the edible composition is a dough.

25. The food product of claim 22, wherein the edible composition is extrudable.

26. The food product of claim 22, wherein the encapsulating material comprises empty yeast cells.

27. The food product of claim 22, wherein the empty cells are combined with a matrix component.

28. The food product of claim 22, wherein the active ingredient is a flavour.

29. The food product of claim 22, wherein the logP of the active ingredient is at least 1.5.

30. The food product of claim 22, in the form of a chewing-gum or fried, baked or extruded product.
